(19) United States
(12) Patent Application Publication
(10) Pub. No.: US 2013/0097033 A1
(43) Pub. Date: Apr. 18, 2013

(54) SYSTEM AND METHOD FOR PROMOTING USE OF REUSABLE SHOPPING BAGS

(71) Applicants: Kristen Brown, Murrells Inlet, SC (US); Mikel Eisenberg, New York, NY (US)

(72) Inventors: Kristen Brown, Murrells Inlet, SC (US); Mikel Eisenberg, New York, NY (US)

(21) Appl. No.: 13/275,058

(22) Filed: Oct. 17, 2011

(51) Int. Cl. G06Q 20/20

(52) U.S. Cl. 705/17; 705/16; 705/20

(57) ABSTRACT

A computer-based method for receiving purchase transaction data generated by a retailer system triggered by an identification device that is part of one or more reusable bags used by a user to carry goods purchased during the purchase transaction. The user is a student or student family member affiliated with a school or other community-based group. A reuse program server receives identification information provided by the identification device that signals the purchase transaction, updates reuse indicator information for the school; calculates a current savings to the school associated with the use of the reusable carrier; and transmits information indicating the current savings to a display device accessible to the user or to representatives of the school.

### RELATED APPLICATION

The present application is related to U.S. patent application Ser. No. 12/372,967, which is entitled “Grocery Cart Bagging System,” was filed on Sep. 1, 2009, and which issued as U.S. Pat. No. 7,992,879 on Aug. 9, 2011. U.S. patent application Ser. No. 12/372,967 and U.S. Pat. No. 7,992,879 are each hereby incorporated by reference in their entireties herein.

### FIELD OF THE INVENTION

The present application is directed to a computer-based system for monitoring use of a reusable product, and more particularly, to a computer-based system for monitoring a user's use of reusable shopping bags for retail sale, and administering a reward to the user at least in part as a function of the economic savings to the retailers.

### BACKGROUND OF THE INVENTION

At 13%, the U.S. residential recycling rate presently lags far behind that of other developed countries. In 2012, the EPA will announce a goal of 70% recycling nationwide. Municipalities remain responsible for developing and implementing waste reduction strategies, but to date have found no magic bullet to help them in these efforts.

In addition to recycling, reuse provides another viable path towards waste reduction. For example, consider the case of single-use shopping bags and other disposable packaging. Within the next decade, every state in the U.S. will have legislation that restricts disposable packaging through taxes or bans. In particular, the retail industry is facing legislative pressure to eliminate the use of single-use plastic bags entirely.

U.S. retailers presently provide shoppers with 200 billion plastic bags each year at a cost to the retailers of two cents per bag, for a total cost of $4 billion dollars. In addition, retailers provide shoppers with 10 billion paper bags each year at a cost to the retailers of nine cents per bag, for a total cost of $90 million dollars. Thus, and in addition to the environmental benefits to be gained from reducing the use of single-use shopping bags, use of reusable bags to reduce the use of single-use bags presents a substantial opportunity to reduce retailers' supply costs. Although a number of grocery stores presently provide shoppers with their own reusable bag alternatives, these have failed to date to ignite behavior change in a significant way among consumers.

One demographic group that has traditionally been enthusiastic about environmentally-focused initiatives are students. Student influence in the U.S. accounts for about $300 billion dollars in purchases annually, so schools are a target market. A number of consumer product groups (CPGs) have attempted environmental outreaches to schools with mixed success (for example, COKE's RECYCLEMANIA, PEPSI's RECYCLE RALLY, and CLOROX's FILTER FOR GOOD).

U.S. secondary schools are looking to find additional revenue streams to compensate for widespread budget cuts, and U.S. secondary school students represent a sizeable market demographic (at least 95,000 schools with student families in 90,000,000 U.S. homes). These schools would clearly benefit from supporting reuse initiatives that deliver at least a portion of the economic savings realized by retailers from shopping bag reuse supported by students and their families back to the schools. CPGs would benefit from understanding the purchasing habits of environmentally-sensitive shoppers in order to promote new sustainable products to this target market and increase the demand for environmentally-sound products.

### SUMMARY OF THE INVENTION

The present invention is directed to a computer-based method and system for receiving purchase transaction data generated by a retailer system triggered by an identification device that is part of a reusable carrier used by a user to carry goods purchased during the purchase transaction. The user is affiliated with an entity (“group partner”) that is enrolled in a reuse program. A reuse program server receives identification information provided by the identification device and signaling a purchase transaction, updates reuse indicator information for the entity; calculates a current savings to the entity associated with the use of the reusable carrier; and transmits information indicating the current savings to a display device accessible to at least one of the entity or the user.

In a preferred embodiment of the present invention, the reusable carrier includes one or more reusable shopping bags, and the entity served is a school or other community-based group. The reuse program server periodically calculates an award amount based on the savings associated with avoiding the use of single-use shopping bags, and transmits information indicating the savings to the display device. Preferably, the server also calculates a rebate amount based on this savings, and invoices an associated retailer for the rebate so that this can be provided to the school.

The identification device in the one or more reusable bags may be based on one of a variety of commercially-available optically-scannable devices and electromagnetically-scannable devices, and preferably includes a barcode label or a radio-frequency identification (“RFID”) device.

The server also preferably receives product information from the purchase transaction, determines whether one or more of the identified purchased products is a target product, updates purchase information for target products purchased by the members of the school, and transmits updated purchase information to the display device. Targeted products are typically identified by product retailers and CPGs as being “sustainable” or otherwise environmentally friendly. Retailers and CPGs may provide incentives and/or rebates for purchase which are administered to schools in accordance with the updated purchase information.

The server also preferably records registration information for the schools and students in a database, and uses this information for selecting and transmitting promotional information to the display device of the school and/or user (for example, including discount offers and environmental tips). The server may interact with various social media in order to broaden its reach in transmitting the promotional information.

### BRIEF DESCRIPTION OF THE DRAWINGS

The invention will become more readily apparent from the Detailed Description of the Invention, which proceeds with reference to the drawings, in which:

FIGS. 1A and 1B are schematic diagrams illustrating an exemplary system architecture according to an embodiment of the present invention;

FIG. 2 provides a flow diagram illustrating the operation of an illustrative embodiment of the program portal of FIG. 1;

FIGS. 3A and 3B provide flow diagrams a process for registering group partners in accordance with the present invention;

FIGS. 4A-4C provide flow diagrams illustrating a process for tracking group member purchases according to the present invention; and

FIG. 5 presents a schematic diagram illustrating a computer system suitable for implementing server elements of the architecture of FIGS. 1 and 2.

### DETAILED DESCRIPTION OF THE INVENTION

Reference will now be made in detail to exemplary embodiments of the invention, including the best modes contemplated by the inventors for carrying out the invention. Examples of these exemplary embodiments are illustrated in the accompanying drawings. While the invention is described in conjunction with these embodiments, it will be understood that it is not intended to limit the invention to the described embodiments. Rather, the invention is also intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In other instances, well-known aspects have not been described in detail in order not to unnecessarily obscure the present invention.

In this specification and the appended claims, the singular forms “a,” “an,” and “the” include plural references unless the context clearly dictates otherwise. Unless defined otherwise, all technical terms used herein have the same meaning as commonly understood to one of ordinary skill in the art to which this invention belongs.

A method and system are disclosed for promoting the use by shoppers of reusable shopping bags at retail stores (for example, at supermarkets). In accordance with the inventive method as disclosed herein, group partners (in a preferred embodiment, schools) are solicited to buy reusable shopping bags for use by group members (students) and their families. An identification device (for example, a barcode or RFID device) is applied to one or more of the bags used by the student and his or her family, for scanning by a retailer's check-out terminal at the completion of a purchase transaction. Similar identification devices may be applied to the purchased items, which are also scanned by the check-out terminal (for example, either individually by bar code or after bagging by RFID code). Scanned information is forwarded by the retailer, for example, to a centralized system that is able to analyze shopping trends for retailers and CPGs. In exchange for this information, the centralized system provides the schools and their student communities with information about levels of reuse of shopping bags, and provides a mechanism by which retailers and CPGs can distribute school reuse rewards and green partner promotions back to the schools and their student communities.

The reuse information and green partner promotions may be preferably distributed by the system to participants directly using one or more of a number of electronic delivery means (for example, including e-mail and FACEBOOK feeds). Green partner promotions are selected to be environmentally friendly and socially responsible, and are preferably both offered at a discount to purchasers in the school communities and with an associated rebate to the participating schools. As a result, students and their families are encouraged to make discounted, socially responsible purchases that benefit their schools, and to exercise their purchasing power by supporting sustainable products and companies.

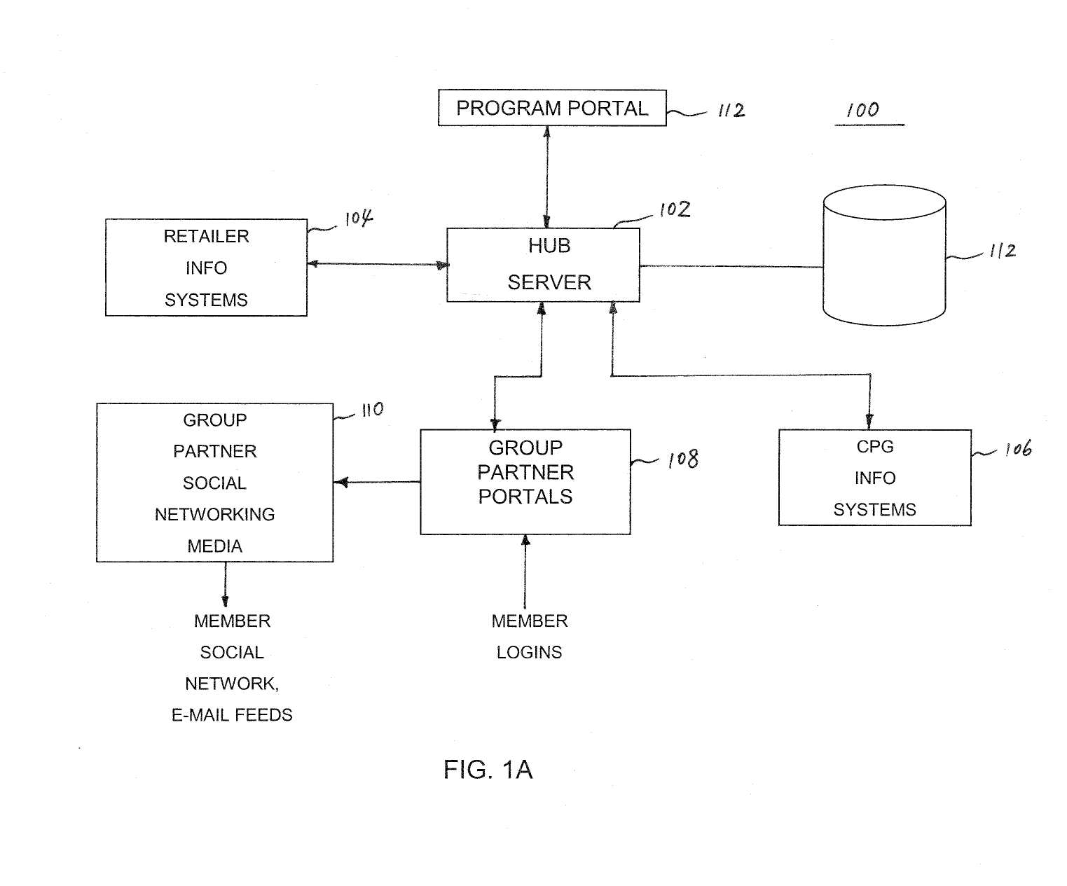

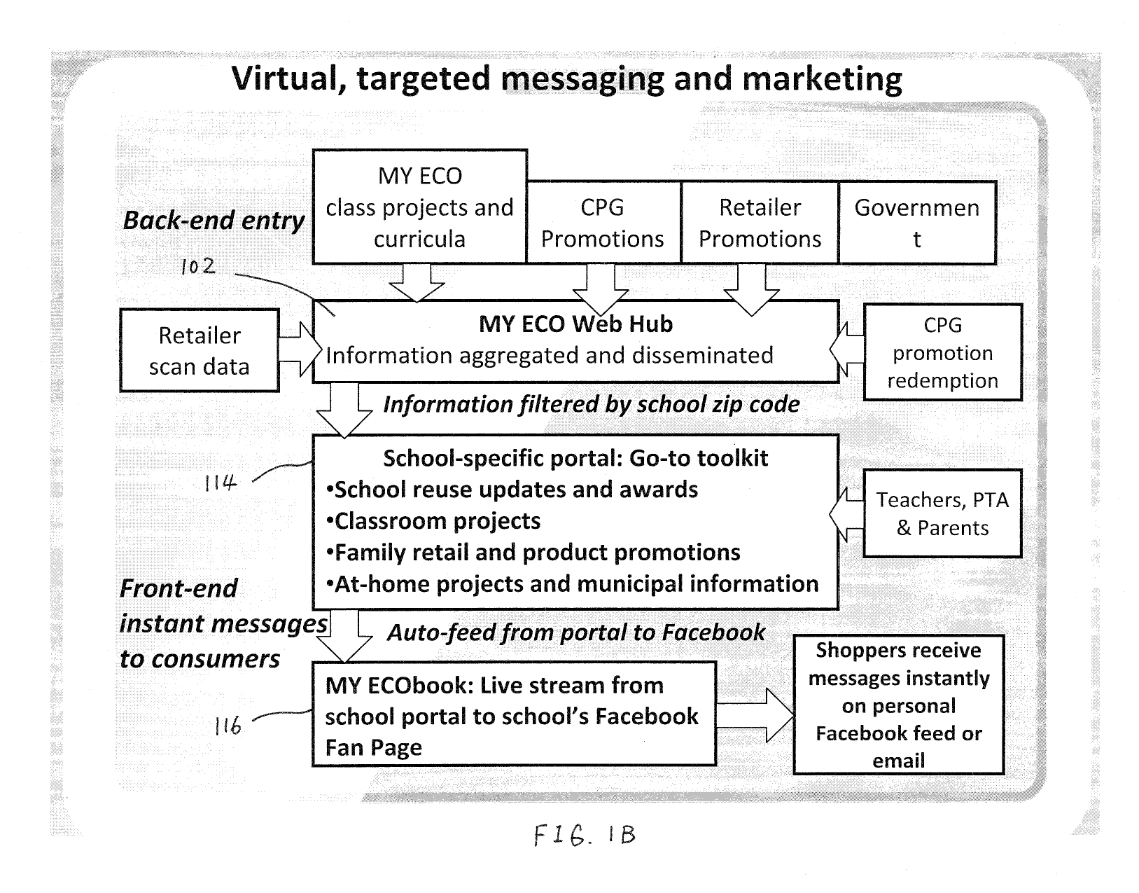

An exemplary process in accordance with the present invention includes the following steps:
A school identifies itself as a participant in the reusable bag school fundraising program (for example, by responding to an invitation to enroll delivered by e-mail or postal mail, or to advertising providing a link to an associated web portal).
Participating schools receive a “school tool kit,” which preferably includes reusable bag samples, order forms for the reusable bags, and coupons and/or other promotional literature including a directory of participating retailers and CPGs. The tool kit may also preferably include a commitment pledge (“School Challenge”) to be adopted by school sponsors (for example, the school's PTA) and presentation materials for a student assembly motivating reuse (including participation in the reusable bag program) and use of sustainable products (including those offered by participating retailers and/or CPUs)
Students fundraise for their school by purchasing reusable bags for their own use and selling reusable bags to other friends and family. Schools receive a portion of the proceeds from bag sales.
A school-specific barcode or other identification device is placed and/or programmed on each bag provided to students and their families.
With reference to an exemplary system architecture 100 as illustrated in FIG. 1, information provided with the reusable bags enables students and their families to register in the reusable bag program, for example, over the Internet at a program portal 112.
Each time a student or family member uses the reusable bags at a partner retailer, the identification device is scanned and stored by a retailer information system 104, and associated information is transmitted by the retailer information system 104 to a hub server 102. Transmission between the hub server 102 and other elements of the architecture 100 may preferably be carried out, for example, securely over the Internet using a Secure Sockets Layer (SSL) or other suitable secure transmission protocol.
Purchased product identifying information (for example, in the form of UPC codes) is also preferably scanned and stored by the retailer information system 104, and transmitted to the hub server 102.
The bag reuse and purchase data from each transaction is processed (“mashed”) in the hub server 102.
Mashed reuse and purchase data is transmitted by the hub server 102 to the retailer system 104. Retailers may use this information, for example, to select targeted advertising, target product promotions and other targeted messages to be selectively distributed to schools and/or to students and their families. On the basis of this data, retailers can be invoiced to pay a contribution to the schools for every reusable bag scan made by the retailer for an associate student (preferably based on a percentage of their supply cost avoidance as a result of not supplying single-use shopping bags for the purchase). Invoices may preferably be delivered by the hub server 102 to the retailer information systems 104.
Retailers may preferable forward the targeted advertising, promotions and messages from the retailer information systems 104 to the hub server 102 for distribution to the students and their families. This information may be accessed by the students and their families via one or more of group partner portals 108 (for example, school web sites accessible via student member logins) and/or group partner social networking media 100 (for example, via students' e-mail and social networking feeds such as FACEBOOK “like” feeds).
CPG partners may also forward targeted advertising and other targeted messages (for example, relating to sustainability) from the CPG information systems 106 in exchange for contributing a portion of sales on specific CPG products. In addition, CPG partners may receive data from the hub server 102 including, for example, shopping trends for individual schools and regions, and use this information to promote appropriate products to schools and family networks.

As an outcome of this process, schools are able to effectively earn money both passively and continuously as students and family members use the reusable bags for purchasing goods at retail partners locations, and as they purchase identified sustainable products offered by CPG partners with school awards.

With reference to FIGS. 1A and 1B, the exemplary architecture 100 is now described in further detail. As described supra, scan data identifying the reusable bags used to purchase products at a retail partner location (and identifying at least some of the purchased products) is transmitted from the retailer information systems 104 to the hub server 102. The hub server preferably stores this transferred information in a conventional storage system 112. Product purchase information pertaining to partner brands and partner retailers is mashed together, analyzed, and sent to the individual school portals 114. Each school portal 114 provides real-time data on reusable bag reuse rates, reuse earnings, and school partner promotional earnings. School portals may, for example, be directly accessed by the PTA, students and their families, and teachers having log-in credentials.

In addition, each school is preferably provided with an ECOBOOK page 116. The ECOBOOK 116 may for example be a school-specific FACEBOOK page that receives auto feeds directly from its associate school portal 114. By way of illustration, one or more of a variety of types of information that are provided to the web hub 102 (including, for example, information pertaining to sustainability projects and curricula, CPG and retailer promotions, and government/regulatory information) may be filtered according to a variety of criteria, and then disseminated to the school portal and fed to the school ECOBOOK 116. Filtering criteria may carried out, for example, using retailer and CPG partner data relating to school member purchases and promotions, including product UPC codes reflected in purchases made by school members, zip codes for retailer locations in proximity to the schools, and sustainability keywords found on the school portals. The ECOBOOK 116 may preferably forward information to students who “like” the ECOBOOK 116 page at the students' personal FACEBOOK pages. Because these personal FACEBOOK pages may in turn be viewable to the students' friends and family across the country, school promotions can in this manner be offered in an expansive manner. The ECOBOOK 116 and personal FACEBOOK pages may of course be viewed by students, family members and others on a variety of conventional display-capable devices including personal computers, smartphones, tablets and the like.

Sustainability curricula may preferably comprise “sponsored” challenges for schools, classes, individuals, and families. The challenges, for example, may be designed focus on natural resource and energy conservation. To compete in challenges, students are expected to utilize analytical thinking and creative ability. Completing or winning a challenge may preferably result in additional funds for schools, as determined by challenge sponsors.

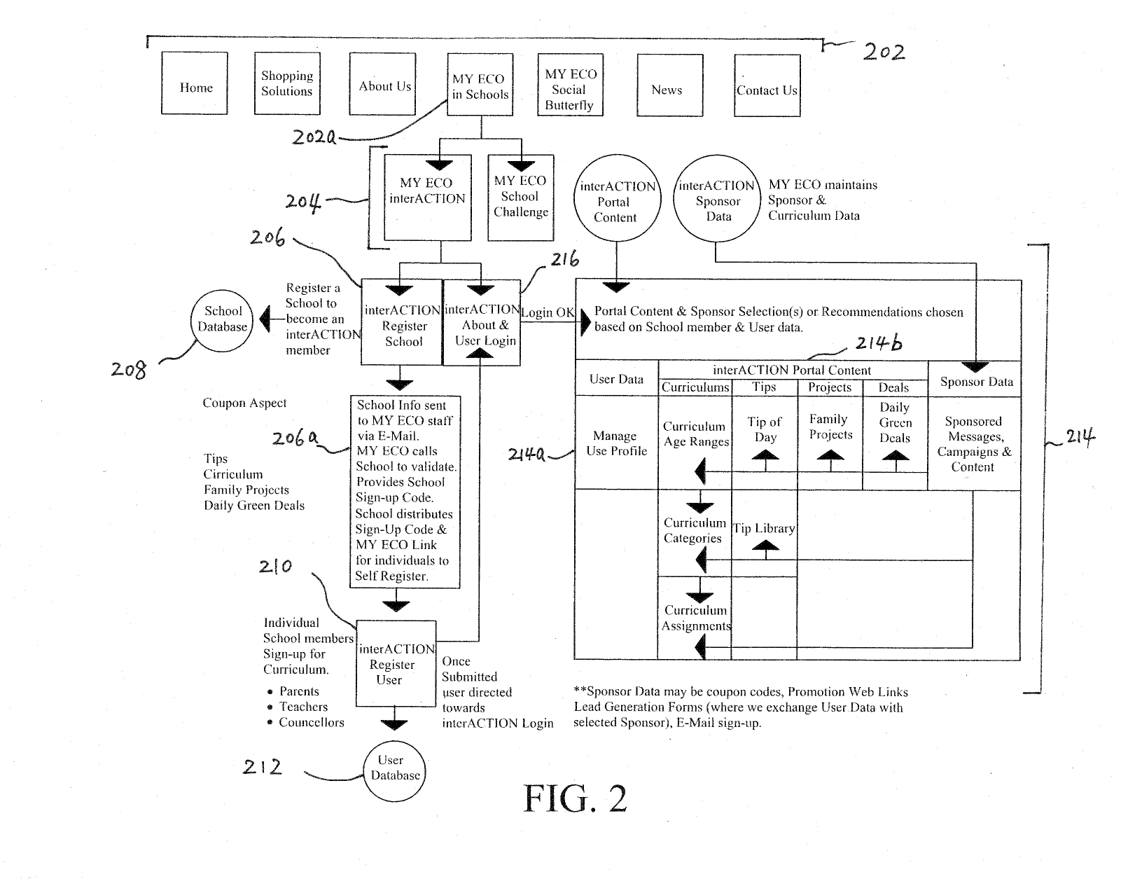

FIG. 2 provides a flow diagram further illustrating the operation of an illustrative embodiment of the program portal 112 of FIG. 1. As shown in FIG. 2, program portal 112 may provide a user with a series of navigation options 202 upon entry into the portal. Upon selecting a schools navigation option 202a, the user is presented with navigation options 204 for registering a school or obtaining site information pertaining to the school. The user is able to navigate to option 206 to make an initial registration request.

In response to the registration request, request information is stored in a school database 208, and forwarded to an agent that contacts the school to confirm the registration and, upon confirmation, to distribute sign-up information (for example, including a sign-up code) and the school tool kit for dissemination by the school. Students who have received the sign-up code are then able to access the portal 112 and navigate to option 210 in order to register as members (“users”) associated with the school. User registration information is stored in a user database 212.

Once registered, users may login to the portal 112 in order to access information pertinent to the school and school members via navigation option 216. Such access requests may be preferably managed by means of suitable database management (DBM) or client relationship management (CRM) software 214 running on the hub server 102 (for example, LEXIS' INTERACTION software). As illustrated in FIG. 2, DBM/CRM software 214 may be used to establish a user profile 214a that identifies and indexes portal content 214b pertinent to the school and to school members. Pertinent content may include one or more of pertinent reuse and sustainability curricula and curricula assignments, family reuse and recycling projects, sustainability “tips of the day,” daily deals on sustainable products featured by retailer and CPG partners, and the like. Additional information and messages from retailed and CPG partners (“sponsors”) may also be identified as pertinent to users via DBM/CRM software 214. Portal content 214b may be provided by retail and CPG partners, government and regulatory organizations, and other sponsors, and stored in the storage system 112 for retrieval via the hub server 102.

User profiles 214a are established during registration and may be updated by authorized users thereafter. Associations among registrants may be accomplished as follows:
Schools register online and provide their zip code, size, type, demographic, and population information.
Individual users log in by school code.
Retail partners register with zip codes.
Municipalities register with zip codes.
CPUs register identifying retail partners.

As an outcome of the registration process, local community partnerships can be identified and built though zip codes. Member demographics (for students and family members, for example) can be constructed as members complete the registration process. In addition, purchasing habits can be identified for schools and other group partners, to form information useful to retailer and CPG partners in targeting information and product offers to these groups.

Reuse and sustainable product use, as measured and captured by the present invention, may provide additional benefits. For example, participating members (for example, students and their families) will be able to monitor change in group habits relating to reuse and use of sustainable products over time. Schools and other member groups can monitor the collective progress of their members to motivate and drive additional change. Levels of reuse and sustainable product use by schools and communities can signal receptivity to environmental change and serve to identify potential community partners for additional environmental change (for example, identifying communities that would be receptive to introducing a new town wide compost program or a new recycling system).

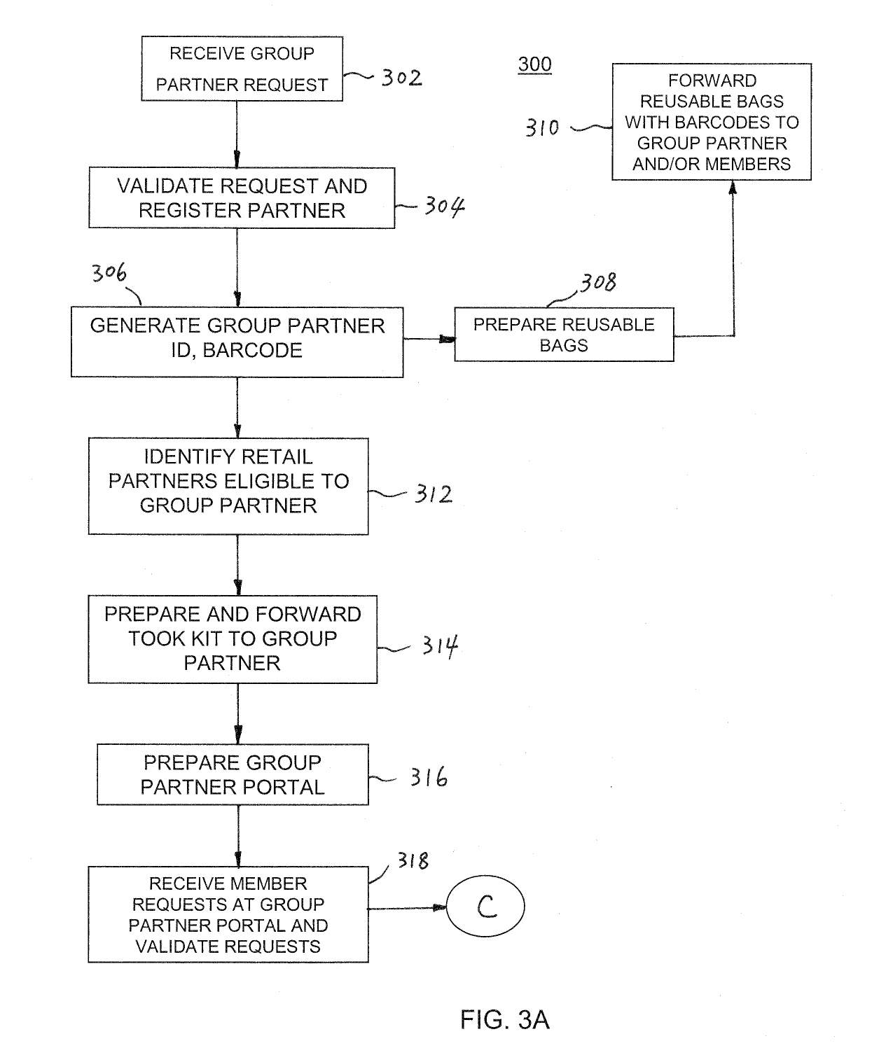

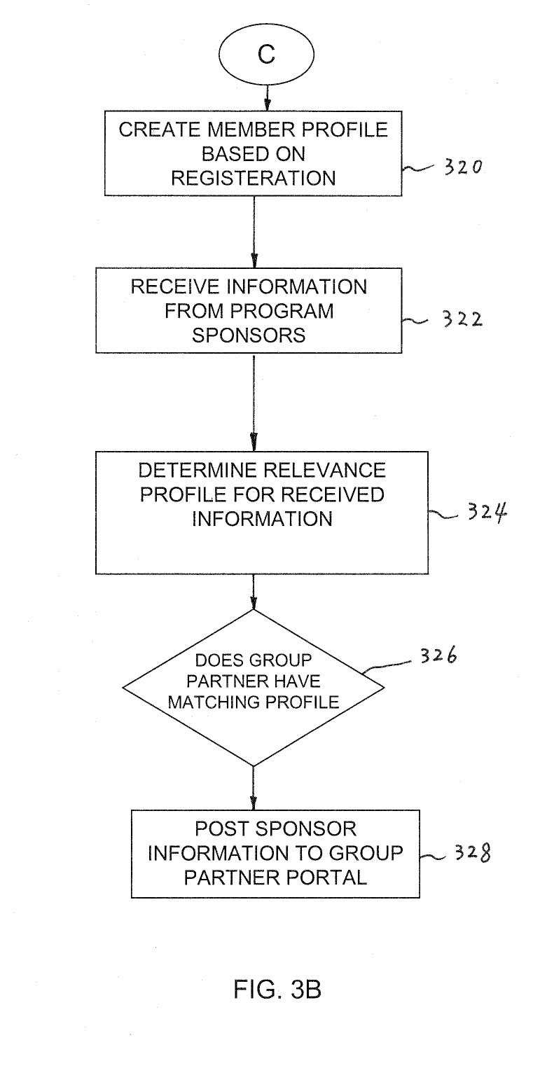

FIGS. 3A and 3B provide flow diagrams illustrating a process 300 by which schools and other group partners may be registered for the reusable bag program in accordance with the present invention. As illustrated in FIG. 3A, at step 302, a registration request is received at the program portal 112 from a school or other group partner. At step 304 and with reference to step 206a as illustrated in FIG. 2, the registration request is validated with the requesting school or group partner. At step 306, a group partner. ID is generated and assigned, and an identification device (for example, barcode or RFID) is prepared. Reusable bags are produced at step 308 that incorporate the identification devices, and an initial supply of reusable bags are forwarded to the group partner at step 310 (or alternatively, as a component of the school tool kit at step 314).

At step 312, retail partners eligible to the group partner are identified (for example, by a proximity analysis according to zip codes). A directory of eligible retail partners is preferably prepared and included in the group partner tool kit prepared at step 314. At step 316, a group partner portal 108 is created (as described, for example, supra with reference to FIG. 1B). At step 318, member requests are received and validated at the group partner portal 108.

As illustrated in FIG. 3B, member profiles are created at step 320 based on member information collected during member registration. These profiles, for example, may identify a variety of demographics including member birth year, family and family member characteristics, current reuse and sustainable product practices, and the like. At step 322, information of various types is received at the hub server from program sponsors (that is, retailer partners, CPG partners, government and regulatory entities, and the like). The received information may include its own relevance profile, or alternatively as indicated at step 324, the hub server 102 may analyze this information in view of the member profiles to prepare a relevance profile. At step 326, the hub server 102 compares the received profiles to member profiles of the school (or other group partner) by means of the relevance profiles or alternative means, and posts relevant information (or, alternatively, links relevant information) to the group partner portals 108 at step 328. As described supra, this information may be further disseminated via group partner social networking media 110.

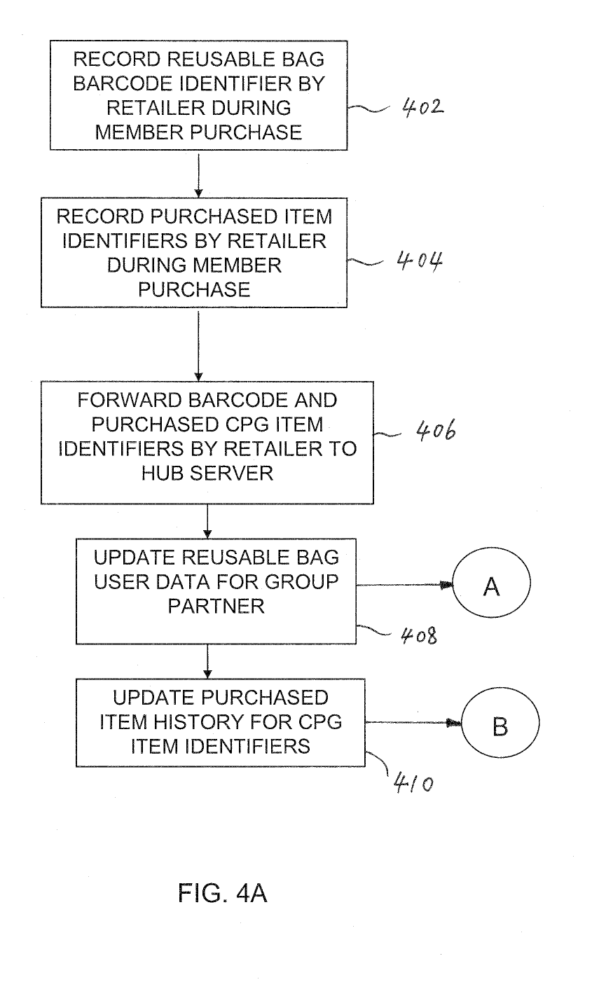

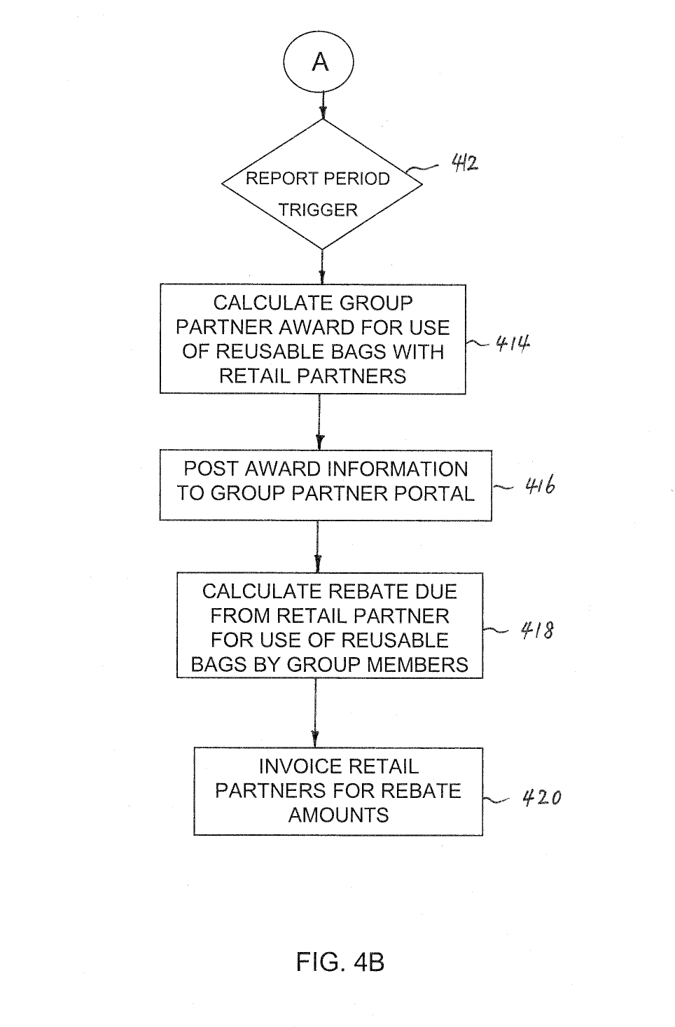

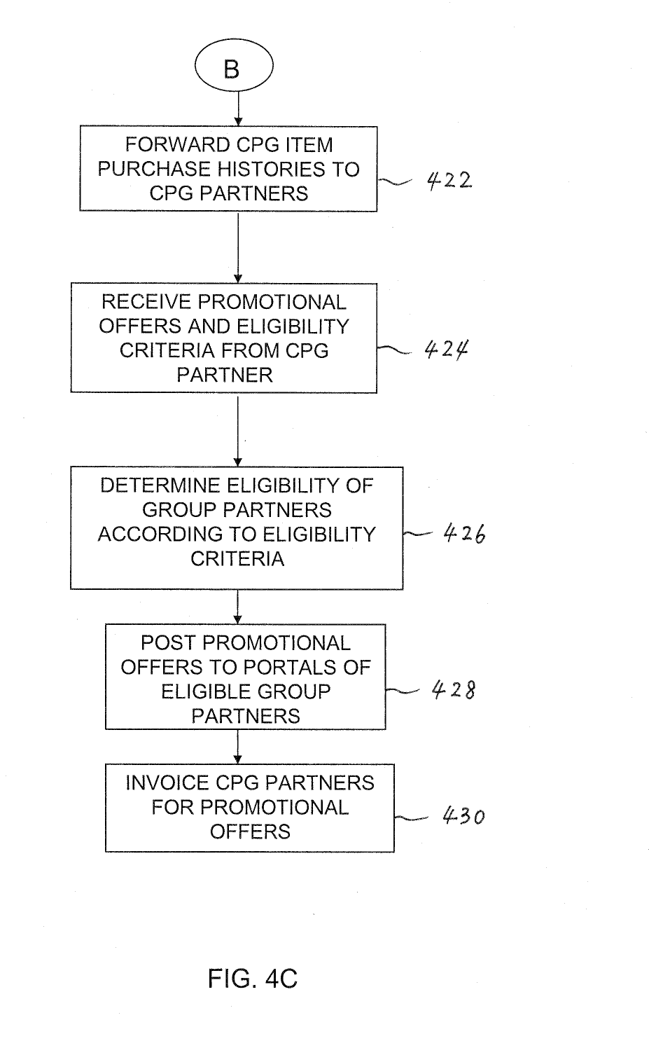

FIGS. 4A-4C further illustrate an illustrative process by which member purchases are tracked according to the present invention. As described supra, a group member (for example, a student member of a participating school) purchases a set of reusable bags to be used for carrying items to be purchased away from the checkout terminal of a participating retailer. At checkout, as illustrated in FIG. 4A, the retailer at step 402 scans the barcode or other identifier on at least one bag at the beginning of the checkout process. At step 404, the retailer also preferably scans item identifiers for at least some of the items to be checked out that have been provided by CPG partners. After this information has been scanned, at step 406, the retailer forwards the scanned information to the hub server 102 of FIG. 1. Intermediately, the retailer may also store the scanned information in the retailer information systems 104. At step 408, the hub server 102 updates reuse information for associated group partners, and preferably stores this information in the storage system 112. At step 410, the hub server 102 updates sustainable product purchase information for the associated school according to CPG product identifiers, and preferably stores this information in the storage system 112.

As illustrated in FIG. 4B, after the hub server 102 updates reuse information for associated group partners at step 408 of FIG. 4A, the hub server 112 preferably determines whether a reporting period trigger has occurred at step 412. If the reporting period has been triggered, the hub server 102 proceeds at step 414 to calculate a group partner award for member use or reusable bags as described supra. At step 416, the hub server 102 posts award information to the group partner portals 108, and also preferably via the portals 108 for broader dissemination via group partner social networking media 110. It is expected that awards indicating significant reuse will further motivate use of the reusable bags by group members. In addition, at step 418, the hub server 102 may calculate rebate amounts due to the group partners from retail partners and CPG partners in conjunction with or in addition to the group partner awards. For example, with reference to retail partners, the rebates may preferably at least in part be based on a portion of the single-use bag cost avoidance achieved by retailers from group member purchases. At step 420, rebate invoices are preferably generated by the hub server 102 and transmitted to the respective retailer information systems 104 and/or CPG information systems 106.

As illustrated in FIG. 4C, after the hub server 102 updates sustainable item purchase information for associated group partners at step 410 of FIG. 4A, this purchase information is preferably forwarded to the CPG information systems 106 for the development of CPG promotional offers. At step 424, promotional offers and eligibility criteria are transmitted by the CPG partners to the hub server 102, where group and group member eligibility is determined at step 426 as described supra with reference t FIGS. 3A, 3B by a comparison of eligibility criteria to group and/or group member profiles. Upon determining eligibility, promotional offers are posted at step 428 to the group partner portals 108 of eligible group partners (or alternatively, by e-mail or FACEBOOK pages of eligible members of group partners) by the hub server 102. If applicable, CPG partners are invoiced for this service by the hub server 102 at step 430

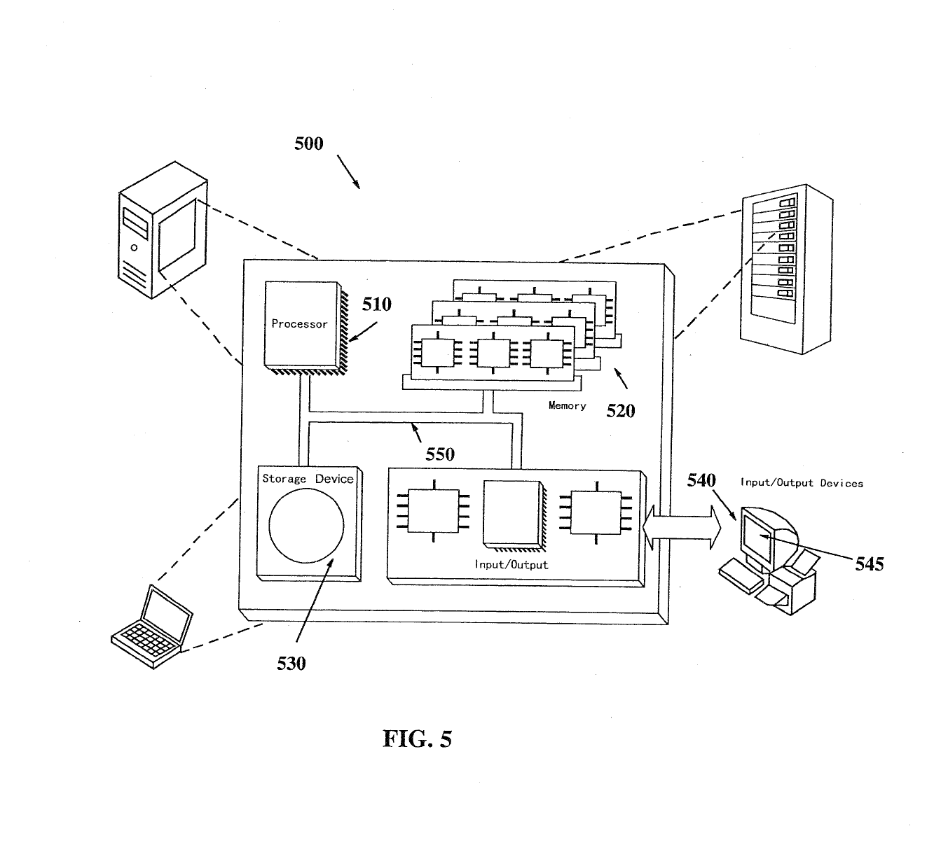

FIG. 5 illustrates a computer system 500 which may be used to implement one or more server elements of the architecture of FIGS. 1 and 2 (for example, including the hub server 102). The computer system 500 as described herein may comprise, for example, a personal computer running the WINDOWS operation system, or a server computer running LINUX or another UNIX-based operating system. The above-described methods of the present invention may be implemented on one or more computer systems 500 as stored program control instructions directed to control application software, for example, including general purpose programming environments such as PYTHON, and database systems such as MySQL.

Computer system 500 includes a processor 510, a memory 520, a storage device 530 and input/output devices 540. One of the input/output devices 540 may include a display 545. Some or all of the components 510, 520, 530 and 540 may be interconnected by a system bus 550. Processor 510 may be single or multi-threaded, and may have one or more cores. Processor 510 executes instructions which in the disclosed embodiments of the present invention comprise steps described in one or more of FIGS. 1-3. These instructions may be stored in the memory 420, or in the storage device 530. Information may be received and output using one or more of the input/output devices 540.

The memory 520 may store information and may be a computer-readable medium, such as volatile or non-volatile memory. The storage device 5 30 may provide storage for the computer system 5 00 including for the example, the previously described database, and may be a computer-readable medium. In various aspects, the storage device 530 may be a flash memory device, a floppy disk drive, a hard disk device, and optical disk device, or a tape device.

Input devices 540 may provide input/output operations for the computer system 500. Input/output devices 540 may include a keyboard, pointing device, and microphone. Input/output devices 540 may further include a display unit for displaying graphical user interfaces, a speaker and a printer. As shown, each computer system 500 may be implemented in a desktop computer, or in a laptop computer, or in a serve r, typically in communication with the Internet via a local area network (“LAN,” not illustrated). Alternatively, for example and with particular reference to the client devices 430 of FIG. 4, the computer system 500 may be implemented as a “smartphone” mobile communications client device 430 accessed remotely from the system 400 via a wireless link to the mobile communication device.

It should of course, be understood that while the present invention has been described with respect to disclosed embodiments, numerous variations are possible without departing from the spirit and scope of the present invention as defined in the claims. For example, the present invention may be applied as a means for establishing fair market value for members of a population of homes, hotel rooms and many other items having quantifiable features that can be compared for the purpose of establishing a fair market value for a representative one of the items. Moreover, it is intended that the scope of the present invention include all foreseeable equivalents to the elements and structures as described herein and with reference to the drawing figures. Accordingly, the invention is to be limited only by the scope of the claims and their equivalents.

We claim:

1. A computer-implemented method for receiving purchase transaction data generated by a retailer system, said purchase transaction data including an entity identifier for a reusable carrier used by a user, said user being affiliated with the entity;
receiving indicator information from the retailer system at a reuse program server, the indicator information indication a use of the reusable carrier in a purchase transaction by the user;
updating re-use indicator information for the entity by the reuse program server to account for the purchase transaction by the user;
calculating a current savings by the reuse program server as a function of the updated re-use indicator information for the entity; and
transmitting information indicating the current savings for display on a display device accessible to at least one of the entity or the user.

2. The computer-implemented method of claim 1, further comprising the steps of
calculating an award amount by the reuse program server based on the current savings; and
transmitting information indicating the award amount for display on a display device accessible to the entity.

3. The computer-implemented method of claim 2, wherein the current savings include a cost savings realized by avoiding the use of a non-reusable carrier.

4. The computer-implemented method of claim 1, wherein the re-use indicator information indicates use of the reusable carrier over a predetermined time period.

5. The computer-implemented method of claim 1, wherein the entity is a school and the user is a student member of the school.

6. The computer-implemented method of claim 1, wherein the reusable carrier comprises one or more reusable shopping bags.

7. The computer-implemented method of claim 6, wherein at least one of the one or more reusable shopping bags comprises an identification device that can be scanned by a retailer terminal device.

8. The computer-implemented method of claim 7, wherein the identification device is selected from the group consisting of optically-scannable devices and electromagnetically-scannable devices.

9. The computer-implemented method of claim 8, wherein the identification device comprises a barcode label.

10. The computer-implemented method of claim 8, wherein the identification device comprises a RFID device.

11. The computer-implemented method of claim 1, further comprising the steps of:
receiving product information from the retailer system at the reuse program server, the product information indicating one or more products purchased from the retailer by the user;
determining by the reuse program server whether one or more of the purchased products indicated by the received product information is a target product;
updating purchase information for target products by the reuse program server; and
transmitting information indicating the updated purchase information for target products to the display device accessible to the least entity or the user.

12. The computer-implemented method of claim 11, further comprising the steps of:
calculating a current award by the reuse program server as the updated purchase information for the entity; and
transmitting information indicating award for display on the display device accessible to the entity or the user.

13. The computer-implemented method of claim 11, further comprising the steps of:
recording registration information of the entity in a database;
recording registration information of the user in a database;
receiving promotional information from one or more of the retailer, a product supplier or a regulatory entity;
comparing the promotional information to one or more of the recorded registration information of the entity, the recorded registration information of the user, the updated re-use indicator information for the entity or the updated purchase information of the entity; and
transmitting the promotional information for display on the display device when the comparing step finds a matching condition between the promotional information and at least one of the recorded registration information of the entity and the recorded registration information of the user.

14. The computer-implemented method of claim 13, wherein the promotional information comprises a discount offer for a purchased product.

15. The computer-implemented method of claim 13, wherein the promotional information comprises a discount offer for another product.

16. The computer-implemented method of claim 13, wherein the promotional information comprises an environmental educational curriculum.

17. The computer-implemented method of claim 13, wherein the promotional information comprises an environmental tip or project.
